(19) United States
(12) Patent Application Publication
(10) Pub. No.: US 2026/0145893 A1
(43) Pub. Date: May 28, 2026

(54) IMAGE FORMING APPARATUS CAPABLE OF REPORTING INFORMATION REGARDING ABNORMAL SECTION OF CONVEYING BELT AND REPORTING METHOD

(71) Applicant: KYOCERA Document Solutions Inc., Osaka (JP)

(72) Inventor: Tatsuya Chuto, Osaka (JP)

(21) Appl. No.: 19/386,128

(22) Filed: Nov. 11, 2025

(30) Foreign Application Priority Data
Nov. 26, 2024 (JP) 2024-205204

(51) Int. Cl. B65H 5/02; B41J 13/08; B41J 29/00

(52) U.S. Cl. CPC B65H 5/021; B41J 13/08; B41J 29/00; B65H 2553/42; B65H 2557/30; B65H 2557/652; B65H 2801/06

(57) ABSTRACT

An image forming apparatus includes, an ink ejection portion, a rotation processing portion, a sensing processing portion, a count processing portion, and a report processing portion. The ink ejection portion ejects ink to a sheet conveyed by a conveying belt provided with marks at a predetermined interval. The rotation processing portion rotates the conveying belt once and brings the conveying belt to a stop. The sensing processing portion senses an abnormal section of the conveying belt using an imaging portion while the rotation processing portion is rotating the conveying belt. The count processing portion counts the number of the marks that pass by the imaging portion until the conveying belt comes to a stop after the abnormal section is sensed. In a case where the abnormal section is sensed, the report processing portion reports sensing of the abnormal section and a result obtained by counting the number of marks.

### INCORPORATION BY REFERENCE

This application is based upon and claims the benefit of priority from the corresponding Japanese Patent Application No. 2024-205204 filed on Nov. 26, 2024, the entire contents of which are incorporated herein by reference.

### BACKGROUND

This disclosure relates to an image forming apparatus and a reporting method.

An inkjet image forming apparatus including a conveying belt which conveys a sheet and an ink ejection portion such as a recording head which ejects ink to the sheet conveyed by the conveying belt has been known. In addition, the image forming apparatus capable of sensing a stain on the conveying belt using a light sensor has been known as the related art.

### SUMMARY

An image forming apparatus according to an aspect of this disclosure includes a conveying belt, an ink ejection portion, marks, an imaging portion, a rotation processing portion, a sensing processing portion, a count processing portion, and a report processing portion. The conveying belt conveys a sheet. The ink ejection portion ejects ink to the sheet conveyed by the conveying belt. The marks are provided on the conveying belt at an interval defined in advance along a circumferential direction of the conveying belt. The imaging portion images the conveying belt. The rotation processing portion rotates the conveying belt at least once and brings the conveying belt to a stop. The sensing processing portion senses an abnormal section of the conveying belt using the imaging portion while the rotation processing portion is rotating the conveying belt. The count processing portion counts the number of the marks that pass by an imaging position by the imaging portion until the conveying belt comes to a stop from the timing at which the sensing processing portion senses the abnormal section. The report processing portion reports, in a case where the sensing processing portion senses the abnormal section, sensing of the abnormal section and a result of counting by the count processing portion after the conveying belt comes to a stop.

A reporting method according to another aspect of this disclosure is executed by an image forming apparatus including a conveying belt that conveys a sheet, an ink ejection portion that ejects ink to the sheet conveyed by the conveying belt, marks provided on the conveying belt at an interval defined in advance along a circumferential direction of the conveying belt, and an imaging portion that images the conveying belt. The reporting method includes a rotation step, a sensing step, a count step, and a report step. In the rotation step, the conveying belt is rotated at least once and brought to a stop. In the sensing step, an abnormal section of the conveying belt is sensed using the imaging portion while the conveying belt is rotating in the rotation step. In the count step, the number of the marks that pass by an imaging position by the imaging portion is counted until the conveying belt comes to a stop from the timing at which the abnormal section is sensed in the sensing step. In the report step, in a case where the abnormal section is sensed in the sensing step, sensing of the abnormal section and a result of counting in the count step are reported after the conveying belt comes to a stop.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a system configuration of an image forming apparatus according to an embodiment of this disclosure.

FIG. 2 is a front view of a configuration of external appearance of the image forming apparatus according to the embodiment of this disclosure.

FIG. 3 is a front view of configurations of an image forming portion, a sheet conveying portion, and a line sensor of the image forming apparatus according to the embodiment of this disclosure.

FIG. 4 is a plan view of the configurations of the image forming portion, the sheet conveying portion, and the line sensor of the image forming apparatus according to the embodiment of this disclosure.

FIG. 5 is a diagram showing a configuration of a conveying belt of the image forming apparatus according to the embodiment of this disclosure.

FIG. 6 is a flowchart showing an example of a first abnormality reporting process that is executed by the image forming apparatus according to the embodiment of this disclosure.

FIG. 7 is a flowchart showing an example of an abnormality sensing process that is executed by the image forming apparatus according to the embodiment of this disclosure.

FIG. 8 is a block diagram showing a system configuration of an image forming apparatus according to another embodiment of this disclosure.

FIG. 9 is a flowchart showing an example of a second abnormality reporting process that is executed by an image forming apparatus according to another embodiment of this disclosure.

### DETAILED DESCRIPTION

Hereinafter, embodiments of this disclosure will be described with reference to the accompanying drawings. It is noted that the following embodiments are specific examples of this disclosure and do not limit the technical scope of this disclosure.

### Configuration of Image Forming Apparatus 100

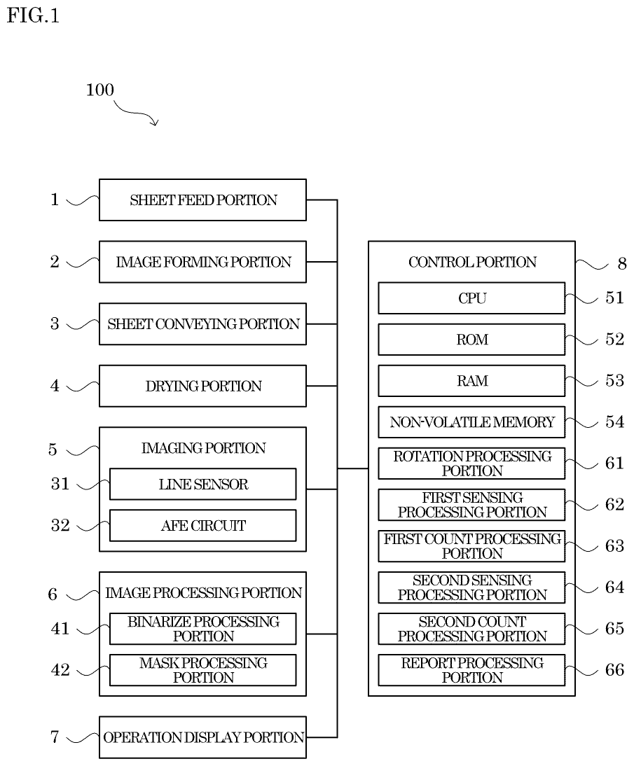

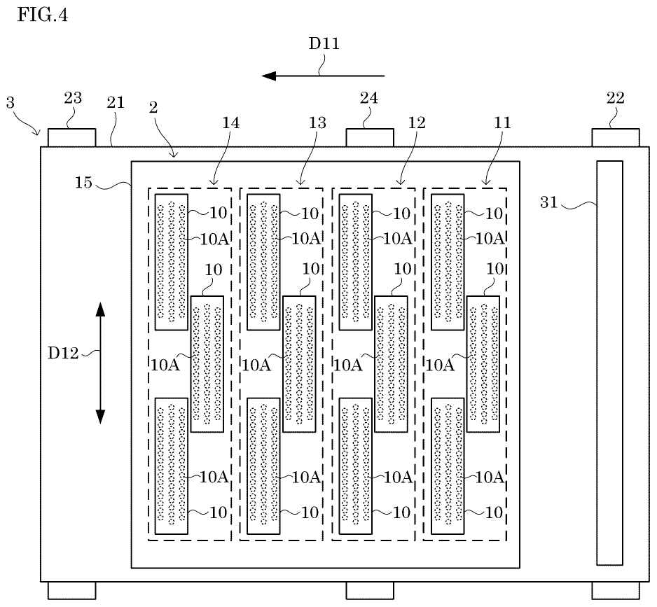

First, the configuration of an image forming apparatus 100 according to an embodiment of this disclosure will be described with reference to FIGS. 1 to 5. It is noted that FIG. 3 shows a conveyance path of a sheet using an arrowed two-dot chain line.

The image forming apparatus 100 is a printer capable of forming an image on a sheet in an inkjet method. It is noted that this disclosure may be applied to a facsimile apparatus, a copier, or a multifunction peripheral capable of forming an image on a sheet in an inkjet method.

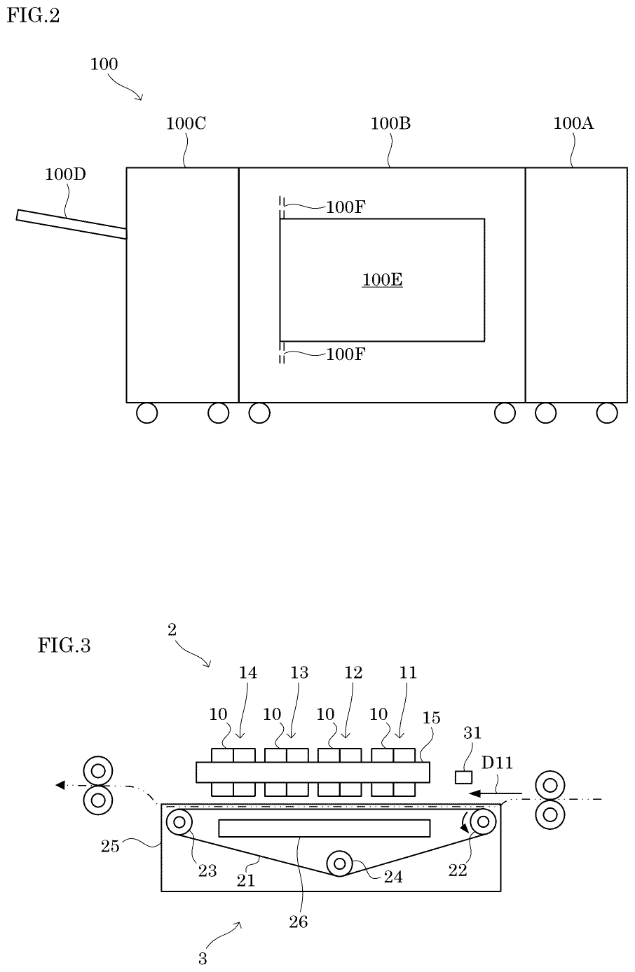

As shown in FIG. 1, the image forming apparatus 100 includes a sheet feed portion 1, an image forming portion 2, a sheet conveying portion 3, a drying portion 4, an imaging portion 5, an image processing portion 6, an operation display portion 7, and a control portion 8. In addition, the image forming apparatus 100 includes a first housing 100A, a second housing 100B, a third housing 100C, and a sheet discharge tray 100D shown in FIG. 2.

The first housing 100A stores the sheet feed portion 1. The second housing 100B stores the image forming portion 2, the sheet conveying portion 3, the imaging portion 5, the image processing portion 6, and the control portion 8. In addition, the upper portion of the second housing 100B is provided with the operation display portion 7. The third housing 100C stores the drying portion 4. A sheet on which an image is formed is discharged to the sheet discharge tray 100D.

As shown in FIG. 2, the second housing 100B includes an exterior cover 100E. The exterior cover 100E is provided to allow an opening formed on the front surface of the second housing 100B to be opened and closed. For example, the exterior cover 100E is provided so as to be pivotable about a rotation shaft 100F along the perpendicular direction shown in FIG. 2. It is possible for a user of the image forming apparatus 100 to check the conditions of the image forming portion 2 and the sheet conveying portion 3 stored in the second housing 100B by opening the exterior cover 100E.

The sheet feed portion 1 includes a sheet feed cassette (not shown). The sheet feed cassette stores a sheet on which an image is to be formed. The sheet feed portion 1 supplies a sheet stored in the sheet feed cassette to the second housing 100B.

The image forming portion 2 forms an image on the sheet supplied to the second housing 100B by the sheet feed portion 1. As shown in FIG. 3, the image forming portion 2 includes line heads 11 to 14 and a head frame 15.

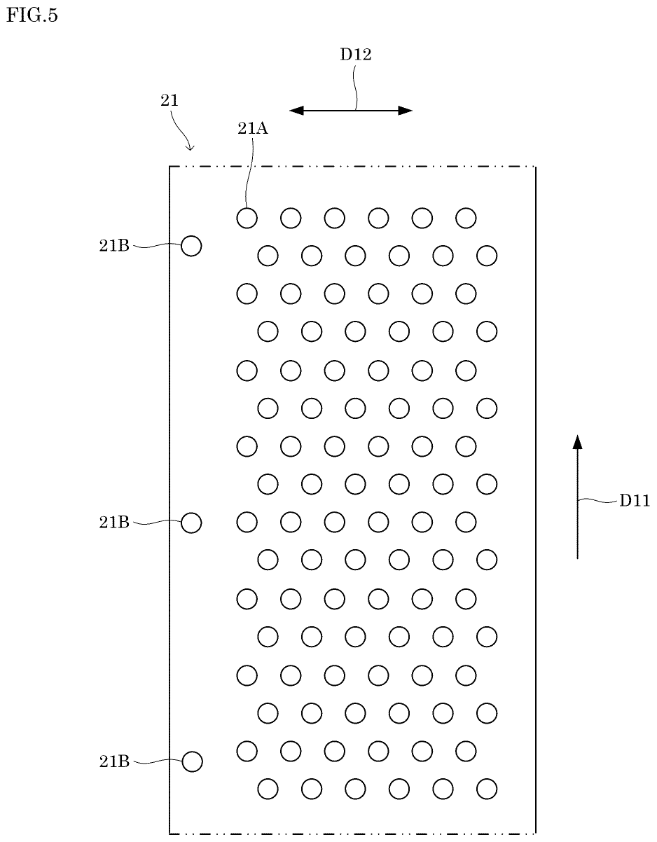

As shown in FIG. 4, each of the line heads 11 to 14 is long in a width direction D12 (see FIG. 4) orthogonal to a conveyance direction D11 (see FIGS. 3 and 4) of a sheet. Specifically, each of the line heads 11 to 14 has the length corresponding to the width of a sheet having the maximum size in the width direction D12 among sheets storable in the sheet feed cassette. The respective line heads 11 to 14 are provided side by side at even intervals along the conveyance direction D11.

As shown in FIG. 4, each of the line heads 11 to 14 includes a plurality of recording heads 10. Each of the recording heads 10 ejects ink to a sheet conveyed by a conveying belt 21 of the sheet conveying portion 3. Each of the recording heads 10 provided to the line head 11 ejects black ink. Each of the recording heads 10 provided to the line head 12 ejects cyan ink. Each of the recording heads 10 provided to the line head 13 ejects magenta ink. Each of the recording heads 10 provided to the line head 14 ejects yellow ink. Each of the line heads 11 to 14 is an example of an ink ejection portion according to this disclosure.

Each of the recording heads 10 includes a plurality of nozzles 10A (see FIG. 4) that each ejects ink. The plurality of nozzles 10A is provided on the surface of the recording head 10 opposed to a sheet conveyed by the sheet conveying portion 3.

In addition, each of the recording heads 10 includes a pressurizing chamber (not shown), a piezoelectric element (not shown), and an individual channel (not shown) corresponding to each of the nozzles 10A. The pressurizing chamber communicates with the nozzle 10A and stores ink. The piezoelectric element causes the nozzle 10A to eject ink by changing the volume of the pressurizing chamber in response to the application of a drive voltage defined in advance. The individual channel is an ink channel provided between the pressurizing chamber and a common channel (not shown) common to the plurality of nozzles 10A. A plurality of the individual channels corresponding to the plurality of nozzles 10A is connected to the common channel. The common channel is connected to an ink supply portion (not shown) that supplies ink to each of the pressurizing chambers.

As shown in FIG. 4, the line head 11 includes the three recording heads 10 arranged in a staggered pattern along the width direction D12. In addition, the other line heads 12 to 14 each include the three recording heads 10 arranged in a staggered pattern along the width direction D12 as with the line head 11.

The head frame 15 supports the line heads 11 to 14. The head frame 15 is supported by the second housing 100B. It is noted that the number of line heads provided to the image forming portion 2 does not have to be four. In addition, the number of recording heads 10 provided to each of the line heads 11 to 14 does not have to be three.

The image forming portion 2 forms an image on a sheet on the basis of print data. The print data is data generated on the basis of image data of a print target. Specifically, the print data includes ejection data corresponding to each of the nozzles 10A. The ejection data is data indicating the amount of ink to be ejected from the nozzle 10A. The print data is generated by converting the respective pixels included in the image data to the ejection data. The image forming portion 2 controls ink ejection by each of the line heads 11 to 14 on the basis of the print data.

As shown in FIG. 3, the sheet conveying portion 3 is disposed below the line heads 11 to 14. The sheet conveying portion 3 conveys a sheet while opposing the sheet to the recording heads 10. As shown in FIG. 3, the sheet conveying portion 3 includes the conveying belt 21 on which a sheet is placed, a first stretching roller 22, a second stretching roller 23, a third stretching roller 24, and a conveyance frame 25. The first stretching roller 22, the second stretching roller 23, and the third stretching roller 24 stretch the conveying belt 21. The conveyance frame 25 supports them. It is noted that the gap between the conveying belt 21 and each of the recording heads 10 is adjusted to cause the gap between the surface of a sheet and the recording head 10 to have a predetermined distance (e.g., 1 mm) at the time of image formation.

The first stretching roller 22 rotates upon receiving rotational driving force supplied from an unillustrated motor. The conveying belt 21 hereby conveys a sheet along the conveyance path illustrated by the arrowed two-dot chain line in FIG. 3. The conveying belt 21 is driven at a constant specific speed defined in advance.

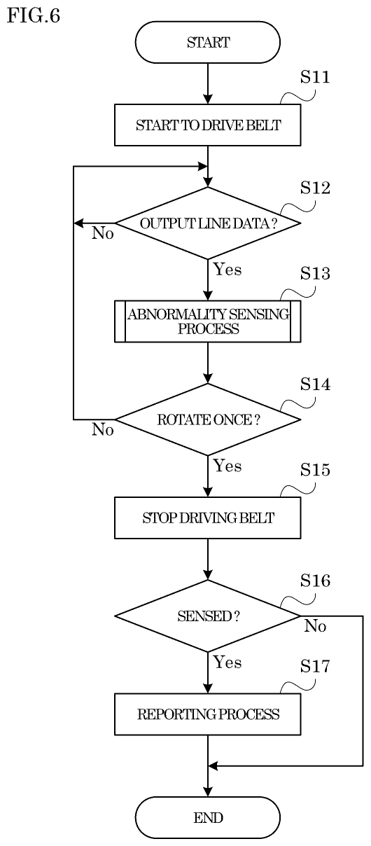

As shown in FIG. 5, the conveying belt 21 includes a large number of air intake ports 21A. In addition, as shown in FIG. 3, the sheet conveying portion 3 includes an air intake device 26 disposed inside the conveying belt 21. The air intake device 26 draws air from the large number of air intake ports 21A on the conveying belt 21. This causes a sheet conveyed by the conveying belt 21 to be adsorbed to the surface of the conveying belt 21.

As shown in FIG. 5, the conveying belt 21 includes a plurality of home position ports 21B. The home position ports 21B are provided at intervals defined in advance along the circumferential direction of the conveying belt 21 at one of the ends of the conveying belt 21 in the width direction D12. Each of the home position ports 21B is an example of a mark according to this disclosure.

In the second housing 100B, a sheet on which an image is formed by the image forming portion 2 is supplied to the third housing 100C.

The drying portion 4 dries an ink image formed on a sheet by the image forming portion 2. For example, the drying portion 4 dries the ink image formed on the sheet by heating the sheet.

In the third housing 100C, the sheet on which the ink image is dried by the drying portion 4 is discharged to the sheet discharge tray 100D.

The imaging portion 5 images the conveying belt 21.

As shown in FIG. 1, the imaging portion 5 includes a line sensor 31 and an analog front-end (AFE) circuit 32.

As shown in FIG. 3, the line sensor 31 is provided on the upstream side of the ejection positions of inks by the line heads 11 to 14 (positions between the line heads 11 to 14 and the conveying belt 21) in the conveyance direction D11 of a sheet in the conveyance path of the sheet extending through the ejection positions. In addition, the line sensor 31 is provided above the conveying belt 21. In addition, as shown in FIG. 4, the line sensor 31 is provided to be long along the width direction D12. The line sensor 31 images the conveying belt 21 and a sheet conveyed by the conveying belt 21.

Specifically, the line sensor 31 is a contact image sensor (CIS). The line sensor 31 includes a plurality of imaging elements disposed side by side in the width direction D12 (see FIG. 4). Each of the imaging elements includes a light emitting portion and a light receiving portion. The light emitting portion emits light to the conveying belt 21. The light receiving portion is provided such that the light receiving portion is allowed to receive light emitted from the light emitting portion and reflected by the conveying belt 21 or the conveyed sheet. The light receiving portion outputs an analog electrical signal corresponding to the amount of received light. The line sensor 31 images an imaging target (the conveying belt 21 or the sheet) in an imaging cycle corresponding to the specific speed. Specifically, the line sensor 31 outputs an analog electrical signal corresponding to an image of the imaging target in the imaging cycle. It is noted that the outer peripheral surface of the conveying belt 21 is colored to have a color like gray that reduces the reflection of light emitted from the light emitting portion more than the base color (white) of the sheet does and reflects the light emitted from the light emitting portion more than ink does.

The AFE circuit 32 is an electronic circuit that converts the analog electrical signal output from the line sensor 31 to a digital electrical signal (image data). For example, the AFE circuit 32 converts the analog electrical signal output from the line sensor 31 to monochrome image data composed of pixels each having 256 levels of gradation from “0” to “255”. For example, a pixel having a gradation value of “0” represents white. In addition, a pixel having a gradation value of “255” represents black. The image data (referred to as “line data” below) output from the AFE circuit 32 is stored in a first region defined in advance in a RAM 53 of the control portion 8. It is noted that a pixel having a gradation value of “0” may represent black and a pixel having a gradation value of “255” may represent white.

The image processing portion 6 is an electronic circuit that processes the print data using image data output from the imaging portion 5. The image processing portion 6 is composed of an electronic circuit such as an integrated circuit (an ASIC, a DSP, or an FPGA). As shown in FIG. 1, the image processing portion 6 includes a binarize processing portion 41 and a mask processing portion 42.

The binarize processing portion 41 reads the line data (an example of a captured image according to this disclosure) stored in the first region of the RAM 53 and binarizes each of the pixels included in the line data into a sheet pixel (an example of a third pixel according to this disclosure) indicating a sheet or a non-sheet pixel (an example of a fourth pixel according to this disclosure) indicating a target different from the sheet. Specifically, the binarize processing portion 41 binarizes each of the pixels included in the line data by comparing the gradation value of the pixel included in the line data and a threshold. More specifically, in a case where the gradation value of a pixel included in the line data is less than the threshold (the gradation value is brighter than a pixel having the threshold), the binarize processing portion 41 converts the pixel to the sheet pixel. In addition, in a case where the gradation value of a pixel included in the line data is greater than or equal to the threshold (the gradation value is darker than or equal to a pixel having the threshold), the binarize processing portion 41 converts the pixel to the non-sheet pixel. The non-sheet pixel indicates the conveying belt 21, the air intake port 21A formed on the conveying belt 21, an ink stain on the surface of the conveying belt 21, or the like. The binarize processing portion 41 stores the binarized line data in a second region defined in advance in the RAM 53 of the control portion 8. The second region is different from the first region.

The mask processing portion 42 masks the region outside the sheet in the print data on the basis of the line data binarized by the binarize processing portion 41.

The image forming portion 2 receives the print data masked by the mask processing portion 42. This makes it possible to prevent ink from being ejected to the region outside the sheet conveyed by the conveying belt 21.

The operation display portion 7 is a user interface of the image forming apparatus 100. The operation display portion 7 includes a display portion and an operation portion. The display portion displays various kinds of information in response to a control instruction from the control portion 8. For example, the display portion is a flat-panel display such as a liquid-crystal display. The operation portion inputs various kinds of information to the control portion 8 in response to an operation of a user. For example, the operation portion includes an operation key and a touch panel.

The control portion 8 integrally controls the image forming apparatus 100. As shown in FIG. 1, the control portion 8 includes a CPU 51, a ROM 52, the RAM 53, and a non-volatile memory 54. The CPU 51 is a processor that executes various calculation processes. The ROM 52 is a non-volatile storage device that stores, in advance, information about a control program or the like for causing the CPU 51 to execute various processes. The RAM 53 is a volatile or non-volatile storage device that is used as a temporary storage memory (work area) for various processes which are executed by the CPU 51. The non-volatile memory 54 is a non-volatile storage device. The CPU 51 integrally controls the image forming apparatus 100 by executing various control programs stored in the ROM 52 in advance.

Incidentally, an image forming apparatus capable of sensing a stain on the conveying belt 21 using a light sensor has been known as the related art.

Here, in a case where the conveying belt 21 has an abnormal section such as an ink stain or a scratch, it is desirable to clean or replace the conveying belt 21. The image forming apparatus according to the related art described above does not, however, report information regarding the abnormal section to a user. It is therefore difficult for the user to clean or replace the conveying belt 21.

In contrast, the image forming apparatus 100 according to the embodiment of this disclosure is capable of reporting the information regarding the abnormal section of the conveying belt 21 as described below.

### Configuration of Control Portion 8

Next, the configuration of the control portion 8 will be described with reference to FIG. 1.

As shown in FIG. 1, the control portion 8 includes a rotation processing portion 61, a first sensing processing portion 62, a first count processing portion 63, a second sensing processing portion 64, a second count processing portion 65, and a report processing portion 66.

Specifically, the ROM 52 of the control portion 8 stores, in advance, an operation control program for causing the control portion 8 to function as each of the processing portions described above. The CPU 51 of the control portion 8 functions as each of the processing portions shown in FIG. 1 by executing the operation control program.

It is noted that some or all of the processing portions included in the control portion 8 may be composed of an electronic circuit. In addition, the operation control program may be a program for causing a plurality of processors to function as the respective processing portions shown in FIG. 1.

The rotation processing portion 61 rotates the conveying belt 21 at least once and brings the conveying belt 21 to a stop.

For example, the rotation processing portion 61 brings the conveying belt 21 to a stop at the timing at which the conveying belt 21 rotates once from the timing at which the rotation speed of the conveying belt 21 reaches the specific speed.

The first sensing processing portion 62 senses the abnormal section of the conveying belt 21 using the imaging portion 5 while the rotation processing portion 61 is rotating the conveying belt 21. The first sensing processing portion 62 is an example of a sensing processing portion according to this disclosure.

Specifically, the first sensing processing portion 62 causes the imaging portion 5 to be outputting the line data until the conveying belt 21 rotates once from the timing at which the rotation speed of the conveying belt 21 reaches the specific speed. In addition, the first sensing processing portion 62 senses the abnormal section on the basis of the line data stored in the first region of the RAM 53.

For example, the first sensing processing portion 62 excludes pixels each indicating the air intake port 21A from the plurality of pixels included in the line data and identifies the pixel (the darkest pixel) having the highest gradation value among the remaining pixels. The first sensing processing portion 62 then determines that the abnormal section is present in a case where the gradation value of the identified pixel is greater than or equal to a first determination value defined in advance. In addition, the first sensing processing portion 62 determines that the abnormal section is absent in a case where the gradation value of the identified pixel is less than the first determination value. The first determination value is set on the basis of the gradation values of respective pixels indicating inks of the four colors in a case where the inks of the respective colors adhering to the conveying belt 21 are imaged using the imaging portion 5. It is noted that the first determination value may be set on the basis of the gradation values of pixels indicating a scratch on the conveying belt 21 in a case where the scratch is imaged using the imaging portion 5. In addition, the first determination value may be optionally changeable in response to an operation of a user on the operation display portion 7.

The first count processing portion 63 counts, using the imaging portion 5, the number of home position ports 21B (see FIG. 5) that pass by the imaging position by the imaging portion 5 until the conveying belt 21 comes to a stop from the timing at which the first sensing processing portion 62 senses the abnormal section. The first count processing portion 63 is an example of a count processing portion according to this disclosure.

Specifically, the first count processing portion 63 senses that the home position ports 21B pass by the imaging position on the basis of the line data stored in the first region of the RAM 53.

It is noted that the image forming apparatus 100 may include a dedicated sensor to sense the home position ports 21B in addition to the line sensor 31. In this case, it is favorable that the first count processing portion 63 count the number of home position ports 21B which pass by the imaging position using the dedicated sensor.

The second sensing processing portion 64 senses a sheet adhering to the conveying belt 21 using the imaging portion 5 while the rotation processing portion 61 is rotating the conveying belt 21.

Specifically, the second sensing processing portion 64 senses a sheet adhering to the conveying belt 21 on the basis of the line data stored in the first region of the RAM 53.

For example, the second sensing processing portion 64 identifies the pixel (the brightest pixel) having the lowest gradation value among the pixels included in the line data. The second sensing processing portion 64 then determines that the sheet is present in a case where the gradation value of the identified pixel is less than a second determination value defined in advance. In addition, the second sensing processing portion 64 determines that the sheet is absent in a case where the gradation value of the identified pixel is greater than or equal to the second determination value. The second determination value is set on the basis of the gradation values of pixels indicating a sheet adhering to the conveying belt 21 in a case where the sheet is imaged using the imaging portion 5. It is noted that the second determination value may be optionally changeable in response to an operation of a user on the operation display portion 7.

As with the first count processing portion 63, the second count processing portion 65 counts, using the imaging portion 5, the number of home position ports 21B (see FIG. 5) that pass by the imaging position until the conveying belt 21 comes to a stop from the timing at which the second sensing processing portion 64 senses the sheet.

Specifically, the second count processing portion 65 senses that the home position ports 21B pass by the imaging position on the basis of the line data stored in the first region of the RAM 53.

In a case where the first sensing processing portion 62 senses the abnormal section, the report processing portion 66 reports the sensing of the abnormal section and a result of counting by the first count processing portion 63 after the conveying belt 21 comes to a stop.

For example, the report processing portion 66 causes the operation display portion 7 to display a first report screen including a message indicating that the abnormal section is sensed and first positional information indicating the position of the abnormal section. The first positional information includes the result of counting by the first count processing portion 63. In addition, the first positional information includes information indicating the position of the abnormal section in the width direction D12. The position of the abnormal section is identified on the basis of the line data.

In addition, in a case where the second sensing processing portion 64 senses a sheet adhering to the conveying belt 21, the report processing portion 66 reports the sensing of the sheet adhering to the conveying belt 21 and a result of counting by the second count processing portion 65 after the conveying belt 21 comes to a stop.

For example, the report processing portion 66 causes the operation display portion 7 to display a second report screen including a message indicating that the sheet adhering to the conveying belt 21 is sensed and second positional information indicating the position of the sheet. The second positional information includes the result of counting by the second count processing portion 65. In addition, the second positional information includes information indicating the position of the sheet in the width direction D12. The position of the sheet is identified on the basis of the line data.

### First Abnormality Reporting Process

The following describes a reporting method according to this disclosure along with examples of procedures of a first abnormality reporting process that is executed by the control portion 8 in the image forming apparatus 100 with reference to FIG. 6. Here, steps S11, S12, . . . denote the numbers of processing procedures (steps) that are executed by the control portion 8.

For example, the first abnormality reporting process is executed in a case where an execution timing defined in advance arrives. For example, the execution timing includes the time at which the image forming apparatus 100 is powered on. In addition, the execution timing includes the time at which the operation mode of the image forming apparatus 100 transitions from a power saving mode to a normal mode. In the power saving mode, less power is consumed than in the normal mode. In addition, the execution timing includes the time at which an instruction to execute a print process of forming an image on a sheet is input.

### Step S11

First, in step S11, the control portion 8 causes the conveying belt 21 to start to be driven.

The control portion 8 inputs, to the imaging portion 5, an instruction to output the line data when the rotation speed of the conveying belt 21 reaches the specific speed. This outputs the line data from the imaging portion 5 in the imaging cycle and stores the line data in the first region of the RAM 53.

### Step S12

In step S12, the control portion 8 determines whether or not the line data is output from the imaging portion 5.

Here, when the control portion 8 determines that the line data is output from the imaging portion 5 (Yes in S12), the control portion 8 shifts the process to step S13. In addition, if the line data is not output from the imaging portion 5 (No in S12), the control portion 8 waits for the imaging portion 5 to output the line data in step S12.

### Step S13

In step S13, the control portion 8 executes an abnormality sensing process described below.

### Abnormality Sensing Process

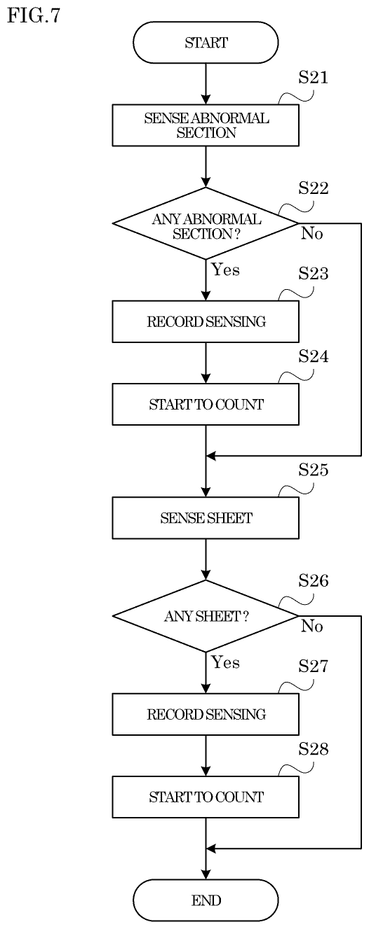

Here, the abnormality sensing process executed in step S13 of the first abnormality reporting process will be described with reference to FIG. 7.

### Step S21

First, in step S21, the control portion 8 senses the abnormal section on the basis of the line data stored for the last time in the first region of the RAM 53. The process in step S21 is an example of a sensing step according to this disclosure and is executed by the first sensing processing portion 62 of the control portion 8.

### Step S22

In step S22, the control portion 8 determines whether or not the abnormal section is sensed through the process in step S21.

Here, when the control portion 8 determines that the abnormal section is sensed (Yes in S22), the control portion 8 shifts the process to step S23. In addition, if the abnormal section is not sensed (No in S22), the control portion 8 shifts the process to step S25.

### Step S23

In step S23, the control portion 8 records the sensing of the abnormal section.

Specifically, the control portion 8 generates first sense information including information indicating the date and time of the sensing of the abnormal section and information indicating the position of the abnormal section in the width direction D12. In addition, the control portion 8 stores the generated first sense information in the non-volatile memory 54 of the control portion 8.

### Step S24

In step S24, the control portion 8 starts to count the number of home position ports 21B (see FIG. 5) that pass by the imaging position. The process in step S24 is an example of a count step according to this disclosure and is executed by the first count processing portion 63 of the control portion 8.

Counting started in the process in step S24 continues until the process in step S15 (see FIG. 6) of the first abnormality reporting process is executed. In addition, a result obtained by counting the number of home position ports 21B that pass by the imaging position is stored in the non-volatile memory 54 of the control portion 8 as part of the first sense information.

### Step S25

In step S25, the control portion 8 senses the sheet adhering to the conveying belt 21 on the basis of the line data stored for the last time in the first region of the RAM 53. The process in step S25 is executed by the second sensing processing portion 64 of the control portion 8.

### Step S26

In step S26, the control portion 8 determines whether or not a sheet adhering to the conveying belt 21 is sensed through the process in step S25.

Here, when the control portion 8 determines that the sheet is sensed (Yes in S26), the control portion 8 shifts the process to step S27. In addition, if the sheet is not sensed (No in S26), the control portion 8 brings the abnormality sensing process to an end.

### Step S27

In step S27, the control portion 8 records the sensing of the sheet adhering to the conveying belt 21.

Specifically, the control portion 8 generates second sense information including information indicating the date and time of the sensing of the sheet and information indicating the position of the sheet in the width direction D12. In addition, the control portion 8 stores the generated second sense information in the non-volatile memory 54 of the control portion 8.

### Step S28

In step S28, the control portion 8 starts to count the number of home position ports 21B (see FIG. 5) that pass by the imaging position. The process in step S28 is executed by the second count processing portion 65 of the control portion 8.

Counting started in the process in step S28 continues until the process in step S15 (see FIG. 6) of the first abnormality reporting process is executed. In addition, a result obtained by counting the number of home position ports 21B that pass by the imaging position is stored in the non-volatile memory 54 of the control portion 8 as part of the second sense information.

The description of the abnormality sensing process will be finished now and the description of the first abnormality reporting process will be started again.

### Step S14

In step S14, the control portion 8 determines whether or not the conveying belt 21 rotates once from the timing at which the rotation speed of the conveying belt 21 reaches the specific speed.

Here, when the control portion 8 determines that the conveying belt 21 rotates once (Yes in S14), the control portion 8 shifts the process to step S15. In addition, if the conveying belt 21 does not rotate once (No in S14), the control portion 8 shifts the process to step S12. This causes the processes in steps S12 and S13 to be in execution until the conveying belt 21 rotates once.

### Step S15

In step S15, the control portion 8 causes the driving of the conveying belt 21 to come to a stop. Each of the processes in steps S11, S14, and S15 is an example of a rotation step according to this disclosure and is executed by the rotation processing portion 61 of the control portion 8.

### Step S16

In step S16, the control portion 8 determines whether or not any one or both of the abnormal section and the sheet adhering to the conveying belt 21 are sensed.

Here, when it is determined that any one or both of the abnormal section and the sheet adhering to the conveying belt 21 are sensed (Yes in S16), the control portion 8 shifts the process to step S17. In addition, if any one or both of the abnormal section and the sheet adhering to the conveying belt 21 are not sensed (No in S16), the control portion 8 brings the first abnormality reporting process to an end.

### Step S17

In step S17, the control portion 8 executes a reporting process of reporting the sensing of any one or both of the abnormal section and the sheet adhering to the conveying belt 21. The process in step S17 is an example of a report step according to this disclosure and is executed by the report processing portion 66 of the control portion 8.

Specifically, in a case where only the abnormal section is sensed, the control portion 8 causes the operation display portion 7 to display the first report screen. In addition, in a case where only the sheet is sensed, the control portion 8 causes the operation display portion 7 to display the second report screen. In addition, in a case where both of the abnormal section and the sheet are sensed, the control portion 8 causes the operation display portion 7 to display the first report screen and the second report screen.

Here, the first report screen includes the result of counting by the first count processing portion 63. This allows a user to move the abnormal section closer to the imaging position by opening the exterior cover 100E (see FIG. 2) and manually rotating the conveying belt 21 reversely such that the home position ports 21B pass by the imaging position the number of times indicated by a result of counting by the first count processing portion 63. It is therefore possible for the user to easily check the abnormal section.

In this way, the image forming apparatus 100 is capable of reporting the information regarding the abnormal section of the conveying belt 21. It is therefore possible for the user to check, in a case where the conveying belt 21 has the abnormal section, the abnormal section and determine whether or not it is necessary to clean or replace the conveying belt 21.

### Other Embodiments

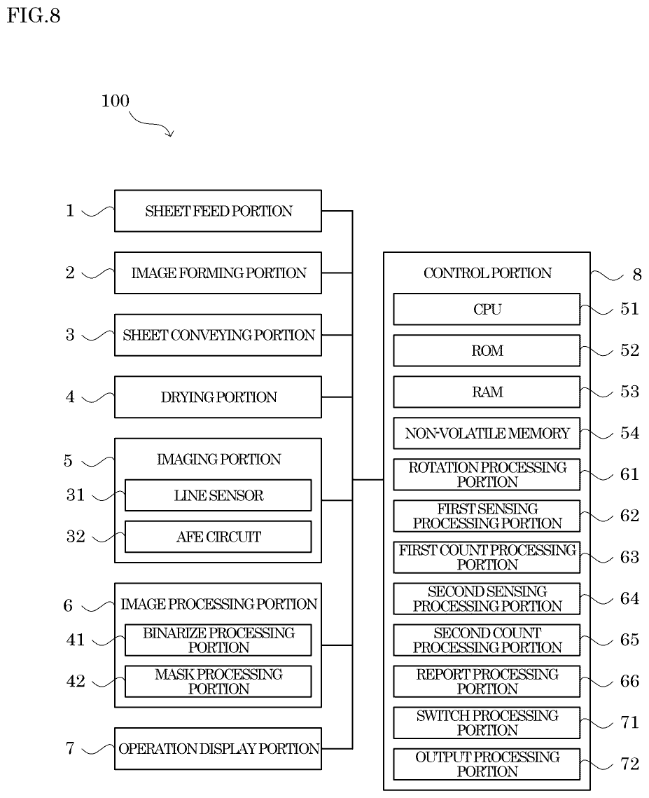

It is noted that the image forming apparatus 100 may include a switch processing portion 71 and an output processing portion 72 shown in FIG. 8.

The switch processing portion 71 switches the threshold that is used to binarize the line data between a first threshold and a second threshold. The first threshold is used to distinguish a belt pixel (an example of a first pixel according to this disclosure) corresponding to the conveying belt and an abnormal-section pixel (an example of a second pixel according to this disclosure) corresponding to the abnormal section. The second threshold is used to distinguish the sheet pixel and the non-sheet pixel.

In a case where the threshold is set to the first threshold, the binarize processing portion 41 binarizes each of the pixels included in the line data into the belt pixel or the abnormal-section pixel. Specifically, in a case where the gradation value of a pixel included in the line data is less than the threshold (the first threshold), the binarize processing portion 41 converts the pixel to the belt pixel. In addition, in a case where the gradation value of a pixel included in the line data is greater than or equal to the threshold (the first threshold), the binarize processing portion 41 converts the pixel to the abnormal-section pixel. The belt pixel indicates the conveying belt 21 or the sheet adhering to the conveying belt 21. The abnormal-section pixel indicates the air intake port 21A formed on the conveying belt 21, an ink stain on the surface of the conveying belt 21, or the like.

In addition, in a case where the threshold is set to the second threshold, the binarize processing portion 41 binarizes each of the pixels included in the line data into the sheet pixel or the non-sheet pixel.

In addition, the mask processing portion 42 masks the region outside the sheet in the print data to be printed on a sheet on the basis of the line data binarized by the binarize processing portion 41 using the second threshold.

That is, the switch processing portion 71 is provided to make it possible to use the binarize processing portion 41 to both generate data that is used to mask the print data and generate a belt image described below.

In a case where the first sensing processing portion 62 senses the abnormal section, the output processing portion 72 outputs the line data acquired by the imaging portion 5.

For example, the output processing portion 72 outputs the line data binarized by the binarize processing portion 41 using the first threshold. That is, the output processing portion 72 outputs the line data stored by the binarize processing portion 41 in the second region in the RAM 53 of the control portion 8.

For example, the output processing portion 72 causes the operation display portion 7 to display a belt image composed of the line data binarized by the binarize processing portion 41 using the first threshold. The belt image is data composed of a plurality of pieces of the line data acquired while the conveying belt 21 is rotating once.

In addition, the output processing portion 72 may print the belt image on a sheet using the image forming portion 2. In addition, the output processing portion 72 may transmit the belt image to a transmission destination designated in advance.

### Second Abnormality Reporting Process

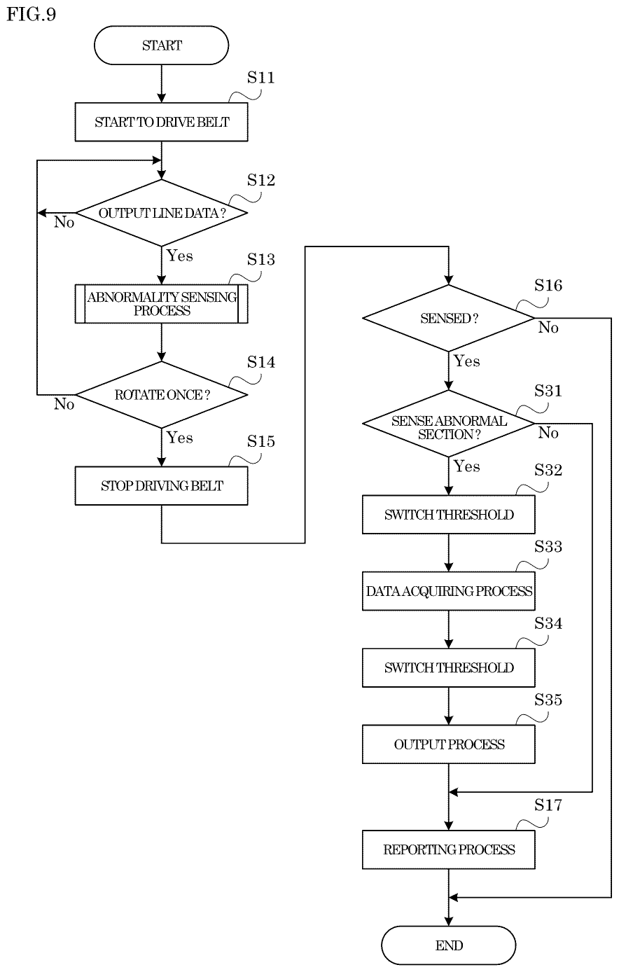

Examples of procedures of a second abnormality reporting process that is executed by the control portion 8 in the image forming apparatus 100 according to another embodiment will be described below with reference to FIG. 9.

As shown in FIGS. 6 and 9, the contents of the second abnormality reporting process are the same as the contents of the first abnormality reporting process except that the processes in steps S31 to S35 are added. The following therefore describes only the processes in steps S31 to S35.

### Step S31

In step S31, the control portion 8 determines whether or not the abnormal section is sensed.

Here, when the control portion 8 determines that the abnormal section is sensed (Yes in S31), the control portion 8 shifts the process to step S32. In addition, if the abnormal section is not sensed (No in S31), the control portion 8 shifts the process to step S17.

### Step S32

In step S32, the control portion 8 switches the threshold from the second threshold to the first threshold. The process in step S32 is executed by the switch processing portion 71 of the control portion 8.

### Step S33

In step S33, the control portion 8 executes a data acquiring process of acquiring the belt image.

Specifically, the control portion 8 causes the conveying belt 21 to be driven again. More specifically, the control portion 8 causes the conveying belt 21 to be being driven until the conveying belt 21 rotates once after the rotation speed of the conveying belt 21 reaches the specific speed.

In addition, the control portion 8 causes the imaging portion 5 to output the line data while the conveying belt 21 is being driven.

In addition, the control portion 8 causes the binarize processing portion 41 to binarize the line data output from the imaging portion 5. This binarizes each of the pixels included in the line data into the belt pixel or the abnormal-section pixel. In addition, the binarized line data (part of the belt image) is stored in the second region of the RAM 53.

### Step S34

In step S34, the control portion 8 switches the threshold from the first threshold to the second threshold. The process in step S34 is executed by the switch processing portion 71 of the control portion 8.

### Step S35

In step S35, the control portion 8 outputs the belt image acquired through the data acquiring process. The process in step S35 is executed by the output processing portion 72 of the control portion 8.

Specifically, the control portion 8 causes the operation display portion 7 to display the belt image. This allows a user to check the shape of the abnormal section without opening the exterior cover 100E.

### Supplementary Notes of Disclosure

The gist of the disclosure extracted from the embodiments described above will be supplementarily noted below. It is noted that the respective configurations and the respective processing functions described in the following supplementary notes can be sorted out and used in any combination.

### Supplementary Note 1

An image forming apparatus including:

a conveying belt configured to convey a sheet;
an ink ejection portion configured to eject ink to the sheet conveyed by the conveying belt;
marks provided on the conveying belt at an interval defined in advance along a circumferential direction of the conveying belt;
an imaging portion configured to image the conveying belt;
a rotation processing portion configured to rotate the conveying belt at least once and bring the conveying belt to a stop;
a sensing processing portion configured to sense an abnormal section of the conveying belt using the imaging portion while the rotation processing portion is rotating the conveying belt;
a count processing portion configured to count a number of the marks that pass by an imaging position by the imaging portion until the conveying belt comes to a stop from the timing at which the sensing processing portion senses the abnormal section; and
a report processing portion configured to report, in a case where the sensing processing portion senses the abnormal section, sensing of the abnormal section and a result of counting by the count processing portion after the conveying belt comes to a stop.

### Supplementary Note 2

The image forming apparatus according to Supplementary Note 1, in which the imaging portion images the conveying belt on an upstream side of an ejection position of the ink by the ink ejection portion in a conveyance path of the sheet in a conveyance direction of the sheet, the conveyance path extending through the ejection position.

### Supplementary Note 3

The image forming apparatus according to Supplementary Note 2, including an output processing portion configured to output a captured image acquired by the imaging portion in the case where the sensing processing portion senses the abnormal section.

### Supplementary Note 4

The image forming apparatus according to Supplementary Note 3, including a binarize processing portion configured to binarize each of pixels included in the captured image into a first pixel corresponding to the conveying belt or a second pixel corresponding to the abnormal section, in which
the output processing portion outputs the captured image binarized by the binarize processing portion.

### Supplementary Note 5

The image forming apparatus according to Supplementary Note 4, including:
a switch processing portion configured to switch a threshold between a first threshold and a second threshold, the threshold being used to binarize the captured image, the first threshold being used to distinguish the first pixel and the second pixel, the second threshold being used to distinguish a third pixel and a fourth pixel, the third pixel indicating the sheet, the fourth pixel indicating a target different from the sheet; and
a mask processing portion configured to mask a region outside the sheet in print data on the basis of the captured image binarized by the binarize processing portion using the second threshold, the print data being printed on the sheet.

### Supplementary Note 6

A reporting method that is executed by an image forming apparatus including a conveying belt configured to convey a sheet, an ink ejection portion configured to eject ink to the sheet conveyed by the conveying belt, marks provided on the conveying belt at an interval defined in advance along a circumferential direction of the conveying belt, and an imaging portion configured to image the conveying belt, the reporting method including:
a rotation step of rotating the conveying belt at least once and bringing the conveying belt to a stop;
a sensing step of sensing an abnormal section of the conveying belt using the imaging portion while the conveying belt is rotating in the rotation step;
a count step of counting a number of the marks that pass by an imaging position by the imaging portion until the conveying belt comes to a stop from the timing at which the abnormal section is sensed in the sensing step; and
a report step of reporting, in a case where the abnormal section is sensed in the sensing step, sensing of the abnormal section and a result of counting in the count step after the conveying belt comes to a stop.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a conveying belt configured to convey a sheet;
an ink ejection portion configured to eject ink to the sheet conveyed by the conveying belt;
marks provided on the conveying belt at an interval defined in advance along a circumferential direction of the conveying belt;
an imaging portion configured to image the conveying belt;
a rotation processing portion configured to rotate the conveying belt at least once and bring the conveying belt to a stop;
a sensing processing portion configured to sense an abnormal section of the conveying belt using the imaging portion while the rotation processing portion is rotating the conveying belt;
a count processing portion configured to count a number of the marks that pass by an imaging position by the imaging portion until the conveying belt comes to a stop from the timing at which the sensing processing portion senses the abnormal section; and
a report processing portion configured to report, in a case where the sensing processing portion senses the abnormal section, sensing of the abnormal section and a result of counting by the count processing portion after the conveying belt comes to a stop.

2. The image forming apparatus according to claim 1, wherein the imaging portion images the conveying belt on an upstream side of an ejection position of the ink by the ink ejection portion in a conveyance path of the sheet in a conveyance direction of the sheet, the conveyance path extending through the ejection position.

3. The image forming apparatus according to claim 2, comprising an output processing portion configured to output a captured image acquired by the imaging portion in the case where the sensing processing portion senses the abnormal section.

4. The image forming apparatus according to claim 3, comprising a binarize processing portion configured to binarize each of pixels included in the captured image into a first pixel corresponding to the conveying belt or a second pixel corresponding to the abnormal section, wherein
the output processing portion outputs the captured image binarized by the binarize processing portion.

5. The image forming apparatus according to claim 4, comprising:
a switch processing portion configured to switch a threshold between a first threshold and a second threshold, the threshold being used to binarize the captured image, the first threshold being used to distinguish the first pixel and the second pixel, the second threshold being used to distinguish a third pixel and a fourth pixel, the third pixel indicating the sheet, the fourth pixel indicating a target different from the sheet; and
a mask processing portion configured to mask a region outside the sheet in print data on a basis of the captured image binarized by the binarize processing portion using the second threshold, the print data being printed on the sheet.

6. A reporting method that is executed by an image forming apparatus including a conveying belt configured to convey a sheet, an ink ejection portion configured to eject ink to the sheet conveyed by the conveying belt, marks provided on the conveying belt at an interval defined in advance along a circumferential direction of the conveying belt, and an imaging portion configured to image the conveying belt, the reporting method comprising:
a rotation step of rotating the conveying belt at least once and bringing the conveying belt to a stop;
a sensing step of sensing an abnormal section of the conveying belt using the imaging portion while the conveying belt is rotating in the rotation step;
a count step of counting a number of the marks that pass by an imaging position by the imaging portion until the conveying belt comes to a stop from the timing at which the abnormal section is sensed in the sensing step; and
a report step of reporting, in a case where the abnormal section is sensed in the sensing step, sensing of the abnormal section and a result of counting in the count step after the conveying belt comes to a stop.
